(19) United States
(12) Patent Application Publication
(10) Pub. No.: US 2003/0117507 A1
(43) Pub. Date: Jun. 26, 2003

(54) Color filter array interpolation

(76) Inventors: Nasser Kehtarnavaz, Plano, TX (US); Hyuk-Joon Oh, College Station, TX (US)

Correspondence Address: TEXAS INSTRUMENTS INCORPORATED, P O BOX 655474, M/S 3999, DALLAS, TX, 75265

(21) Appl. No.: 10/325,310

(22) Filed: Dec. 20, 2002

Related U.S. Application Data
(60) Provisional application No. 60/343,132, filed on Dec. 21, 2001.

(51) Int. Cl. H04N 9/64; H04N 3/14

(52) U.S. Cl. 348/242; 348/246; 348/254; 348/223.1; 348/280

(57) ABSTRACT

Color filter array interpolation with directional derivatives using all eight nearest neighbor pixels. The interpolation method applies to Bayer pattern color CCDs and MOS detectors and is useful in digital still cameras and video cameras.

### CROSS-REFERENCE TO RELATED APPLICATIONS

This application claims priority from provisional application: Serial No. 60/343,132, filed Dec. 21, 2001. The following patent applications disclose related subject matter: Serial Nos. 09/______, filed ______ (-----). These referenced applications have a common assignee with the present application.

### BACKGROUND OF THE INVENTION

The invention relates to electronic devices, and more particularly to color filter array interpolation methods and related devices such as digital cameras.

There has been a considerable growth in the sale and use of digital cameras in the last few years. Nearly 10M digital cameras were sold worldwide in 2000, and this number is expected to grow to 40M units by 2005. This growth is primarily driven by consumers' desire to view and transfer images instantaneously. FIG. 5 is a block diagram of a typical digital still camera (DSC) which includes various image processing components, collectively referred to as an image pipeline. Color filter array (CFA) interpolation, gamma correction, white balancing, color space conversion, and JPEG compression/decompression constitute some of the key image pipeline processes. Note that the typical color CCD consists of a rectangular array of photosites (pixels) with each photosite covered by a filter (CFA): either red, green, or blue. In the commonly-used Bayer pattern CFA one-half of the photosites are green, one-quarter are red, and one-quarter are blue. And the color conversion from RGB to YCbCr (luminance, chrominance blue, and chrominance red) used in JPEG is defined by:

Y=0.299R+0.587G+0.114B

Cb=−0.16875R−0.33126G+0.5B

Cr=0.5R−0.41859G−0.08131B

so the inverse conversion is:

R=Y+1.402Cr

G=Y−0.34413Cb−0.71414Cr

B=Y+1.772Cb

where for 8-bit colors the R, G, and B will have integer values in the range 0-255 and the CbCr plane will be correspondingly discrete.

To recover a full-color image (all three colors at each pixel), a method is therefore required to calculate or interpolate values of the missing colors at a pixel from the colors of its neighboring pixels. Such interpolation methods are referred to as CFA interpolation, reconstruction or demosaicing algorithms in the image processing literature.

It is easier to understand the underlying mathematics of interpolation by looking at 1D rather than 2D signals. The CFA samples can be regarded as the samples of a lower resolution image or a signal x_{CFA}(n). The resolution can be doubled by inserting zeros between x_{CFA}(n) samples to form a new expanded signal x(n) as shown in FIG. 3. The expansion is going to squeeze the frequency response in the frequency domain as indicated in FIG. 4. Assuming no aliasing of high frequency content, by performing a low-pass filtering operation, interpolated samples can be generated in-between the original samples. In FIG. 3, the interpolated signal is denoted by y(n).

The differences between bilinear interpolation, cubic/B-spline interpolation and other similar CFA interpolation techniques lie in the shape of the low-pass filter used. However, they all share the same underlying interpolation mathematics.

In general, the low-pass filtering operation leads to the removal of some high frequency image content. The situation is less serious for green color (or luminance) as compared to blue and red colors (or chrominance) since there are twice as many green pixels in the Bayer pattern. The artifacts introduced by low-pass filtering appear as aliasing in high frequency areas, blurry looking image in areas of uniform color, and zigzaginess, known as the “zipper effect”, along edges. To overcome such artifacts, many methods have been developed to incorporate high frequency or edge information into the interpolation process.

Indeed, CFA interpolation methods can be classified into two major categories: non-adaptive interpolation and edge-adaptive interpolation methods. In non-adaptive interpolation methods, the interpolation process is carried out the same way in all parts of the image regardless of any high frequency color variations, whereas in edge-adaptive methods, the interpolation process is altered in different parts of the image depending on high frequency colorcontent.

Some edge-adaptive interpolation methods first detect the edges in the image and then use them to guide the interpolation process. Examples of such techniques appear in Allebach et al, Edge-Directed Interpolation, IEEE Proc. ICIP 707 (1996) and Dube et al, An Adaptive Algorithm for Image Resolution Enhancement, 2 Signals, Systems and Computers 1731 (2000). This approach is computationally expensive due to performing explicit edge detection.

Another category of edge-adaptive techniques incorporates the edge information into the interpolation process and hence are computationally more attractive. For example, see U.S. Pat. No. 4,642,678 (Cok), Kimmel, Demosaicing: Image Reconstruction from Color CCD Samples, 8 IEEE Trans.Image Proc. 1221 (1999), Li et al, New Edge Directed Interpolation, Proc. 2000 IEEE ICIP 311, and Muresan et al, Adaptive, Optimal-Recovery Image Interpolation, Proc. 2001 IEEE ICASSP 1949.

However, all of these methods have quality limitations.

### SUMMARY OF THE INVENTION

The present invention provides camera systems and methods of CFA interpolation using directional derivatives for all eight nearest neighbors of a pixel.

This has advantages including enhanced quality of interpolation.

### BRIEF DESCRIPTION OF THE DRAWINGS

The drawings are heuristic for clarity.

FIG. 1 is a flow diagram for a preferred embodiment method.

FIGS. 2a-2b illustrate pixel notations.

FIGS. 3-4 show one-dimensional interpolation.

FIG. 5 is a block diagram of still camera system.

### DETAILED DESCRIPTION OF THE PREFERRED EMBODIMENTS

### 1. Overview

Preferred embodiment digital camera systems include preferred embodiment CFA interpolation methods which use a weighted sum of nearest neighbor direction predictors. FIG. 1 is a flow diagram for a first preferred embodiment method

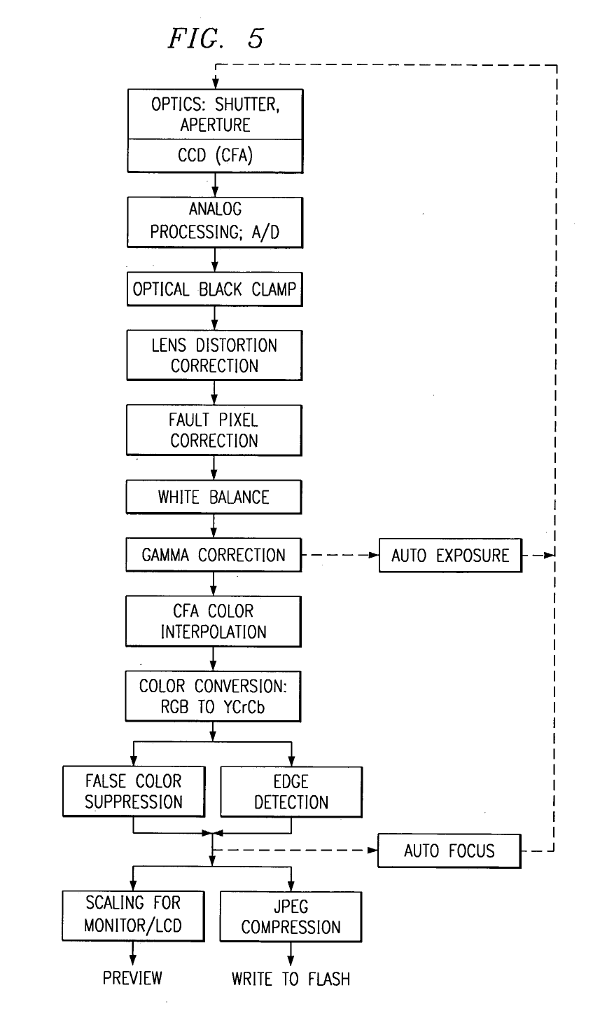

FIG. 5 shows in functional block form a system (camera) which may incorporate preferred embodiment CFA interpolation methods. The functions of FIG. 5 can be performed with digital signal processors (DSPs) or general purpose programmable processors or application specific circuitry or systems on a chip such as both a DSP and RISC processor on the same chip with the RISC processor as controller. Further specialized accelerators, such as CFA color interpolation and JPEG encoding, could be added to a chip with a DSP and a RISC processor. Captured images could be stored in memory either prior to or after image pipeline processing. The image pipeline functions could be a stored program in an onboard or external ROM, flash EEPROM, or ferroelectric RAM for any programmable processors.

### 2. First Preferred Embodiment

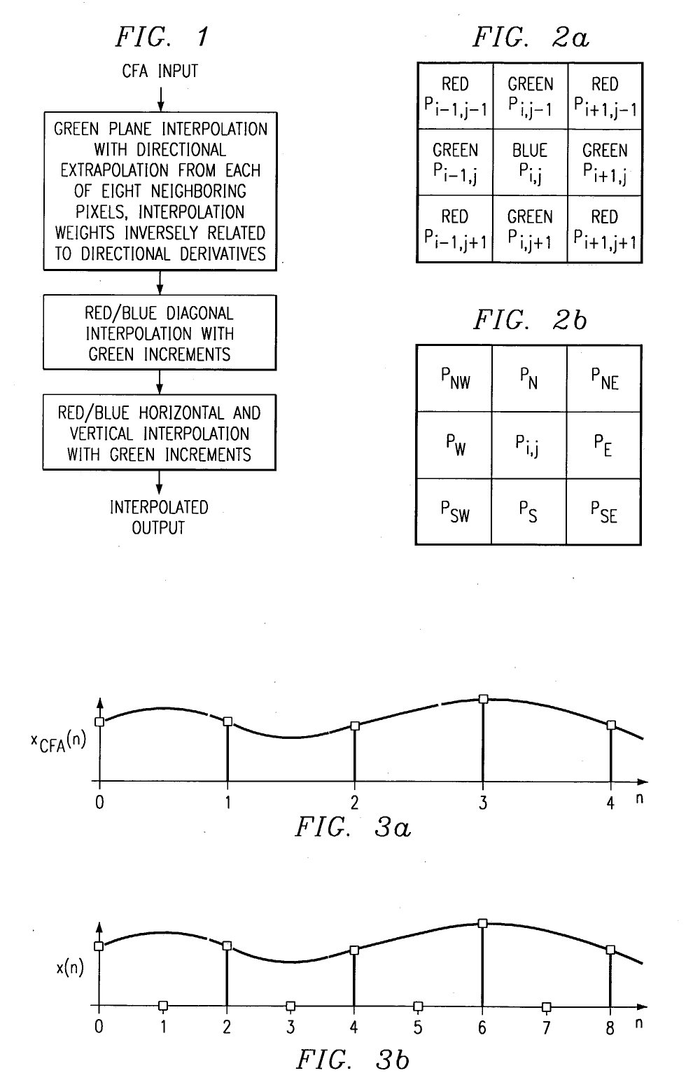

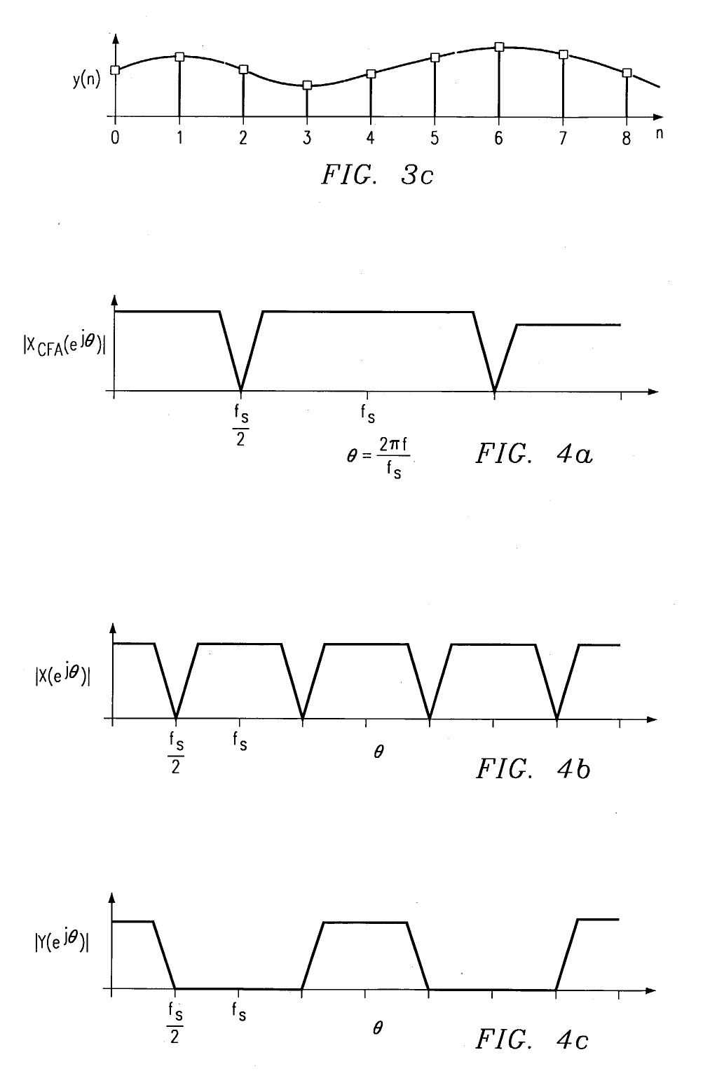

The first preferred embodiment Bayer CFA interpolation initially interpolates the green color plane using all CFA pixel values, and then interpolates the red and blue color planes using the previously-interpolated green color plane. FIG. 2a shows a pixel at (i,j) plus the eight nearest neighbor pixels where the pixel color values P_{m,n} denote the original Bayer CFA values; additionally, FIG. 2a indicates the pattern of Bayer CFA colors for the case of P_{i,j} being blue.

The green interpolation calculates a missing green pixel value, G_{i,j}, as a weighted average of eight green predictors, [symbol] ₓ, one predictor for each of the eight nearest neighbor pixel directions (labeled by the compass directions from the missing pixel as illustrated in FIG. 2b).

G_{i,j}=α_{N} [symbol] _{N}+α_{W} [symbol] _{W}+α_{S} [symbol] _{S}+α_{E} [symbol] _{E}+α_{NW} [symbol] _{NW}+α_{SW}z,901 _{SW}+α_{SE}z,901 _{SE}+α_{NE} [symbol] _{NE}

where α_{N}+α_{W}+α_{S}+α_{E}+α_{NW}+α_{SW}+α_{SE}+α_{NE}=1, so the weights are normalized. The green predictors are roughly linear extrapolations using directional derivatives, plus the weights vary inversely with the directional derivatives to de-emphasize extrapolation across an edge in the image. In particular, presume the pixel at (i,j) is not a green pixel in the Bayer CFA where i is the column index and j is the row index; e.g., FIG. 2a. Then compute a green value G_{i,j} for this pixel as follows. First, note that the four nearest-neighbor pixels (horizontal and vertical) in the CFA have green values G_{i,-1j,} G_{i-1,j,} G_{i,j+1,} and G_{i+1,j} and the four diagonal-neighbor pixels have all red (blue) values R_{i-1,j-1,} R_{i+1,j-1,} R_{i-1,j+1,} and R_{i+1,j+1}. These eight neighboring pixels are labeled by the eight compass directions (N,S,E,W,NE,SE,NW,SW) with N-S corresponding to an array column (index i) and W-E to an array row (index j); see FIG. 2b. Then for each of these eight neighboring pixels define a green prediction value ( [symbol] ₓ) for the pixel at (i, j) as follows:

[symbol]

_{N}=G_{i,j-1}+ΔG_{N}

[symbol]

_{W}=G_{i-1,j}+ΔG_{W}

[symbol]

_{S}=G_{i,j+1}+ΔG_{S}

[symbol]

_{E}=G_{i+1,j}+ΔG_{E}

[symbol]

_{NW}=(G_{i,j-1}+G_{i-1,j})/2+ΔG_{NW}

[symbol]

_{SW}=(G_{i,j+1}+G_{i-1,j})/2+ΔG_{SW}

[symbol]

_{SE}=(G_{i,j+1}+G_{i+1,j})/2+ΔG_{SE}

[symbol]

_{NE}=(G_{i,j-1}+G_{i+1,j})/2+ΔG_{NE}

Thus for N,S,E,W the predictor value is the neighboring green pixel value (e.g., G_{i,j-1}) plus an increment (e.g., ΔG_{N}), and for NW,SE,NW,SW the predictor value is a green value created as the average of two neighboring green pixels' values (e.g., (G_{i,j-1}+G_{i-1,j})/2) and deemed located at the midpoint between the neighboring pixel centers (which is the corner of the (i,j) pixel in the corresponding direction) plus an increment (e.g., ΔG_{NW}). The increments are just linear extrapolations: each increment is the product of the (approximated) directional derivative at the midpoint between the green value location (either neighboring green pixel center or the created green value at the (i,j) pixel corner) and the center of the predicted (i,j) pixel multiplied by the distance (in terms of the distance between pixel centers horizontally or vertically) between the green value location and the center of (i,j) as follows:

ΔG_{N}=(Dy_{i,j}+Dy_{i,j-1})/2

ΔG_{W}=(Dx_{i,j}+Dx_{i-1,j})/2

ΔG_{S}=(−Dy_{i,j}−Dy_{i,j+1})/2

ΔG_{E}=(−Dx_{i,j}−Dx_{i+1,j})/2

ΔG_{NW}=(Du_{i,j}+[Dy_{i,j-1}+Dx_{i-1,j}]/2)/2

ΔG_{SW}=(−Dv_{i,j}−[Dy_{i,j+1}−Dx_{i-1,j}]/2)/2

ΔG_{SE}=(−Du_{i,j}−[Dy_{i,j+1}+Dx_{i+1,j}]/2)/2

ΔG_{NE}=(Dv_{i,j}+[Dy_{i,j-1}−Dx_{i+1,j}]/2)/2

Here the horizontal directional derivatives Dx_{m,n}, the vertical directional derivatives Dy_{m,n}, and the diagonal directional derivatives Du_{m,n} and Dv_{m,n} are defined as:

Dx_{m,n}=(P_{m+1,n}−P_{m-1,n})/2

Dy_{m,n}=(P_{m,n+1}−P_{m,n-1})/2

Du_{m,n}=(P_{m+1,n+1}−P_{m-1,n-1})/2√2

Dv_{m,n}=(P_{m-1,n+1}−P_{m+1,n-1})/2√2

where P_{m,n} is the Bayer CFA color value at pixel (m,n); see FIG. 2a. Note that for each (m,n) P_{m+1,n}, P_{m-1,n}, P_{m,n+1}, and P_{m,n-1} are all of the same color. Hence, Adams's color correlation model implies that the directional derivatives are well-defined and independent of color. (Recall the color correlation model presumes locally B=G+k_{B} and R=G+k_{R} for some constants k_{B} and k_{R}, so pixel value differences within a color plane locally have the constant canceling out.) The division by 2 in Dx_{m,n} and Dy_{m,n} corresponds to the pixels in the difference being a distance 2 apart, and similarly the 2√2 in the diagonal directional corresponds to the pixels in the difference being a distance 2√2 apart.

In particular, for ΔG_{N} the distance between the north green value at (i,j−1) and the predicted pixel at (i,j) equals 1, and the (approximated) directional derivative at the midpoint between (i,j−1) and (i,j) is taken to be the average of the y directional derivatives at (i,j−1) and the y directional derivative at (i,j). Similarly for the south, west, and east.

For ΔG_{NW} the green value is located at the NW corner of the (i, j) pixel and is taken to be the average of the green values at the N pixel (i,j−1) and the W pixel (i−1,j), and the diagonal directional derivative at this green value location is taken to be the average of the y directional derivative at the N pixel and the x directional derivative at the W pixel. Thus the distance from this green value location to the center of the (i, j) pixel is 1/√2. And the diagonal directional derivative at the midpoint between this green value location and the center of the pixel at (i, j) is taken to be the average of the diagonal derivative at (i,j) and the average-defined diagonal derivative at the green value location. Again, NE, SW, and SE are similar.

The weights are defined with an inverse correspondence to the magnitude of the directional derivative: this de-emphasizes the predictions across edges where the directional derivative would be large. Various measures of magnitude could be used; however, absolute differences (rather than squared differences or other magnitude measurements) allow a more efficient implementation on a fixed-point processor. Thus define the (not normalized) weights:

w_{N}=1/(1+|Dy_{i,j}|+|Dy_{i,j-1}|)

w_{W}=1/(1+|Dx_{i,j}|+|Dx_{i-1,j}|)

w_{S}=1/(1+|Dy_{i,j}|+|Dy_{i,j+1}|)

w_{E}=1/(1+|Dx_{i,j}|+|Dx_{i+1,j}|)

w_{NW}=1/(1+|Du_{i,j}|+|Du_{i-1,j-1}|)

w_{SW}=1/(1+|Dv_{i,j}|+|Dv_{i-1,j+1}|)

w_{SE}=1/(1+|Du_{i,j}|+|Du_{i+1,j+1}|)

w_{NE}=1/(1+|Dv_{i,j}|+|Dv_{i+1,j-1}|)

and so normalize by α_{N}=w_{N}/Σ, α=w_{W}/Σ, α_{S}=w_{S}/Σ, α_{E}=w_{E}/Σ, α_{NW}=w_{NW}/Σ, α_{SW}=w_{SW}/Σ, α_{SE}=w_{SE}/Σ, and α_{NE}=w_{NE}/Σ where Σ=w_{N}+w_{W}+w_{S+w}_{E}+w_{NW}+w_{SW}+w_{SE}+w_{NE}. This completes the green plane interpolation.

After performing the above green interpolation, which can be viewed as the luminance interpolation, proceed with the red and blue (chrominance) interpolation. This time use the directional derivative approach to interpolate the differences B−G and R−G noting that these differences become more severe at edges as compared to uniform color areas. B−G and R−G differences correspond to a well-behaved chrominance or color space and match well with the color correlation model. (In contrast, the B/G and R/G ratios do not correspond to a well-behaved color space due to the possibility of having low green values.)

In particular, for blue/red interpolation again proceed in two steps. In the first step, interpolate the missing blues/reds at red/blue locations by using the same weights (recall the directional derivatives were color independent) and analogous diagonal predictors as in the foregoing green interpolation:

B_{i,j}=(w_{NW} [symbol] _{NW}+w_{SW} [symbol] _{SW}+w_{SE} [symbol] _{SE}+w_{NE} [symbol] _{NE})/K

and

R_{i,j}=(w_{NW} [symbol] _{NW}+w_{SW} [symbol] _{SW}+w_{SE} [symbol] _{SE}+w_{NE} [symbol] _{NE})/K

where K=w_{NW}+w_{SW}+w_{SE}+w_{NE} normalizes the weights.

The red and blue predictors are defined analogously with the green extrapolations:

[symbol]

_{NW}=B_{i-1,j-1}+ΔB_{NW}

[symbol]

_{SW}=B_{i-1,j+1}+ΔB_{SW}

[symbol]

_{SE}=B_{i+1,j+1}+ΔB_{SE}

[symbol]

_{NE}=B_{i+1,j-1}+ΔB_{NE}

and

[symbol]

_{NW}=R_{i-1,j-1}+ΔR_{NW}

[symbol]

_{SW}=R_{i-1,j+1}+ΔR_{SW}

[symbol]

_{SE}=R_{i+1,j+1}+ΔR_{SE}

[symbol]

_{NE}=R_{i+1,j-1}+ΔR_{NE}

The directional increments are taken as equal to the corresponding green increments from the previously interpolated green plane:

+ΔB_{NW}≅ΔG_{NW}=G_{i,j}−G_{i-1,j-1}

+ΔB_{SW}≅ΔG_{SW}=G_{i,j}−G_{i-1,j+1}

+ΔB_{SE}≅ΔG_{SE}=G_{i,j}−G_{i+1,j+1}

+ΔB_{NE}≅ΔG_{NE}=G_{i,j}−G_{i+1,j-1}

and

+ΔR_{NW}≅ΔG_{NW}=G_{i,j}−G_{i-1,j-1}

+ΔR_{SW}≅ΔG_{SW}=G_{i,j}−G_{i-1,j+1}

+ΔR_{SE}≅ΔG_{SE}=G_{i,j}−G_{i+1,j+1}

+ΔR_{NE}≅ΔG_{NE}=G_{i,j}−G_{i+1,j-1}

The foregoing red/blue interpolation on blue/red pixels is thus equivalent to interpolation of the differences B_{i,j}−G_{i,j} (and R_{i,j}−G_{i,j}) with the same weights; that is:

B_{i,j}=G_{i,j}+{w_{NW}(B_{i-1,j-1}−G_{i-1,j-1})+w_{SW}(B_{i-1,j+1}−G_{i-1,j+1})+w_{SE}(B_{i+1,j+1}−G_{i+1,j+1})+w_{NE}(B_{i+1,j+1}−G_{i+1,j+1})}/K

where again K=w_{NW}+w_{SW}+w_{SE}+w_{NE} normalizes the weights.

In the second step, interpolate the missing blues/reds at green locations by using horizontal and vertical direction predictors:

B_{i,j}=(w_{N} [symbol] _{N}+w_{W} [symbol] _{W}+w_{S} [symbol] _{S}+w_{E} [symbol] _{E})/M

and

R_{i,j}=(w_{N} [symbol] _{N}+w_{W} [symbol] _{W}+w_{S} [symbol] _{S}+w_{E} [symbol] _{E})/M

where M=w_{N}+w_{W}+w_{S}+w_{E} normalizes the weights. Again, the predictors are defined by color values plus (horizontal and vertical) increments:

[symbol]

_{N}=B_{i,j-1}+ΔB_{N}

[symbol]

_{W}=B_{i-1,j}+ΔB_{W}

[symbol]

_{S}=B_{i,j+1}+ΔB_{S}

[symbol]

_{E}=B_{i+1,j}+ΔB_{E}

and

[symbol]

_{N}=R_{1,j-1}+ΔR_{N}

[symbol]

_{W}=R_{i-1,j}+ΔR_{W}

[symbol]

_{S}=R_{i,j+1}+ΔR_{S}

[symbol]

_{E}=R_{i+1,j}+ΔR_{E}

with the increments again taken equal to the green horizontal and vertical increments.

+ΔB_{N}≅ΔG_{N}=G_{i,j}−G_{i,j-1}

+ΔB_{W}≅ΔG_{W}=G_{i,j}−G_{i-1,j}

+ΔB_{S}≅ΔG_{S}=G_{i,j}−G_{i+i,j}

+ΔB_{E}≅ΔG_{E}=G_{i,j}−G_{i+1,j}

and

+ΔR_{N}≅ΔG_{N}=G_{i,j}−G_{i,j-1}

+ΔR_{W}≅ΔG_{W}=G_{i,j}−G_{i-1,j}

+ΔR_{S}≅ΔG_{S}=G_{i,j}−G_{i,j+1}

+ΔR_{E}≅ΔG_{E}=G_{i,j}−G_{i+1,j}

This completes the CFA interpolation. Note that the overall effect is a filtering with a filter kernel having coefficients varying according to the eight neighboring pixels and associated directional derivatives.

### 3. Alternative Preferred Embodiment

An alternative preferred embodiment replaces the directional derivative combination (Du_{i,j}+[Dy_{i,j-1}+Dx_{i-1,j}]/2)/2 of the green interpolation with a combination of two pure diagonal derivatives in a 3 to 1 ratio: (3Du_{i,j}+Du_{i-1,j-1})/4 and this avoids relying on horizontal and vertical derivatives but extends farther in the diagonal direction.

### 4. Modifications

The preferred embodiments may be modified in various ways while retaining one or more of the features of predictions from neighboring pixels by linear extrapolations with estimated directional derivatives and predictions from all eight neighboring pixels with weightings of the predictions varying inversely on the directional derivatives. For example, the input color planes may be varied such as yellow-cyan-magenta-green, the weights may depend on other combinations of directional derivatives in parallel directions, either directly or indirectly, such as when three of the four directional derivatives used for weights in parallel directions (e.g., W_{N} uses Dx_{i,j} plus Dx_{i,j}₁ and w_{S} uses Dx_{i,j} plus Dx_{i,j+1}) have large magnitudes and the fourth a small magnitude (note that Dx_{i,j} is counted twice and thus must be large), then drop the common (large) directional derivative from the weight with the small directional derivative. and thereby only retain the small one; . . . .

What is claimed is:

1. A method of color filter array interpolation, comprising:
(a) finding a color for a target pixel by a weighted sum of predictions, wherein each of said predictions corresponds a neighbor pixel of said target pixel and said each of said predictions has a value which linearly depends upon a directional derivative in the direction from said neighbor pixel to said target pixel.

2. A digital camera system, comprising:
(a) a sensor;
(b) an image pipeline coupled to said sensor, said image pipeline including a CFA interpolator which finds a color for a target pixel by a weighted sum of predictions, wherein each of said predictions corresponds a neighbor pixel of said target pixel and said each of said predictions has a value which linearly depends upon a directional derivative in the direction from said neighbor pixel to said target pixel; and
(c) an output coupled to said image pipeline.

3. A method of color filter array interpolation, comprising:
(a) finding a color for a target pixel by a weighted sum of eight predictions, wherein each of said eight predictions corresponds a nearest neighbor pixel of said target pixel and said each of said eight predictions has a weight which depends upon a directional derivative in the direction from said neighbor pixel to said target pixel.

4. A digital camera system, comprising:
(a) a sensor;
(b) an image pipeline coupled to said sensor, said image pipeline including a CFA interpolator which finds a color for a target pixel by a weighted sum of eight predictions, wherein each of said eight predictions corresponds a nearest neighbor pixel of said target pixel and said each of said eight predictions has a weight which depends upon a directional derivative in the direction from said neighbor pixel to said target pixel; and
(c) an output coupled to said image pipeline.
